(19) United States
(12) Patent Application Publication
(10) Pub. No.: US 2020/0412010 A1
(43) Pub. Date: Dec. 31, 2020

(54) LIGHTWEIGHT ANTENNA UNIT, LIGHTWEIGHT ARRAY ANTENNA, AND ASSEMBLY METHOD FOR ANTENNA UNIT

(71) Applicant: AAC Technologies Pte. Ltd., Singapore City (SG)

(72) Inventors: Qingchen Chu, Shenzhen (CN); Lulong Li, Shenzhen (CN); Yuehua Yue, Shenzhen (CN); Shuming Li, Shenzhen (CN); Hongjun Wang, Shenzhen (CN)

(21) Appl. No.: 16/996,935

(22) Filed: Aug. 19, 2020

Related U.S. Application Data
(63) Continuation of application No. PCT/CN2019/094092, filed on Jun. 30, 2019.

(51) Int. Cl. H01Q 19/13; H01Q 1/20; H01Q 19/02; H01Q 1/38

(52) U.S. Cl. CPC H01Q 19/134; H01Q 1/38; H01Q 19/025; H01Q 1/20

(57) ABSTRACT

A lightweight antenna unit and an assembly method therefor, and an array antenna are provided. The antenna unit includes: a radiating sheet including elastic first fixing portions; an insulating bracket including a bracket body, mounting portions, and second fixing portions and first assembling portions that are respectively provided at top and bottom of the bracket body; feeding sheets received in the mounting portion in such a manner that a feeding pin at bottom of the feeding sheet extends out of the mounting portion; and a feeding network circuit board including second assembling portions fixedly cooperating with the first assembling portions to mount the insulating bracket to it. The first and second fixing portions cooperate to mount the radiating sheet to the insulating bracket. The lightweight antenna unit and the array antenna reduce cost, have few welding points and good assembly consistency, and are suitable for automated production.

### TECHNICAL FIELD

The present invention relates to the field of mobile communication technology and, in particular, to a lightweight antenna unit, a lightweight array antenna, and an assembly method for the antenna unit.

### BACKGROUND

With our demand for high transmission rates and high stability of communication quality, and continuous development of mobile communication technology, the newly popularized fourth-generation (4G) communication can no longer fully meet our demand for large throughput data volume, and the fifth generation (5G) communication has gradually become a research hotspot in the communication industry.

The most important characteristics of 5G includes big data, public connection and scene experience. The big data means large data volume, high data rate, and most service data, and provides support for the development of mobile internet; the public connection means that a large number of Internet of Things terminal users access, to provide an ability to connect everything; the scene experience is to provide excellent user experience corresponding to different scenes. During application, mobile communication data and Internet of Things communication data have experienced explosive growth of orders of magnitude.

As one of key technologies of 5G, an array antenna technology can greatly improve a processing capacity of a network system by arranging an antenna matrix with a scale of dozens of or hundreds of antennas at a base station side. Therefore, with the deployment of mobile communication networks towards refinement and deep coverage base station integration, when the fifth generation mobile communication system (5G) uses a large-scale array antenna, the communication system puts forward higher requirements for miniaturization, lightweight and low cost of the array antenna.

Most base station antennas adopt metal die-casting or integrated circuit antennas. When adopting the metal die-casting, a weight of a die-casted antenna is too large. When adopting the integrated circuit antenna, assembly and production of the integrated circuit antenna is complicated, precision of the assembled integrated circuit antenna is not high, so it is not suitable for automated production, and there are as many as a dozen feeding welding points, making consistency between the antenna units poor.

Therefore, the antenna unit technology still needs to be improved.

### SUMMARY

Embodiments of the present invention provide a lightweight antenna unit, a lightweight array antenna, and an assembly method for the antenna unit, which have a plurality of one-time fixing structures that are simply and efficiently assembled, and few feeding welding points, are suitable for automated production and have high assembly precision.

A first aspect, an embodiment of the present invention provides a lightweight antenna unit, including a radiating sheet, an insulating bracket, a plurality of feeding sheets, and a feeding network circuit board. A plurality of first fixing portions that is elastic is provided on the radiating sheet. The insulating bracket includes a bracket body, and a plurality of mounting portions, a plurality of second fixing portions and a plurality of first assembling portions that are mounted to the bracket body. The plurality of second fixing portions is provided at a top of the bracket body, and the plurality of first assembling portions is provided at a bottom of the bracket body. The feeding network circuit board includes a plurality of second assembling portions and a feeding network. Each of the plurality of feeding sheets is received in a corresponding mounting portion of the plurality of mounting portions in such a manner that a feeding pin at bottom of the feeding sheet extends out of the corresponding mounting portion. The plurality of first fixing portions and the plurality of second fixing portions cooperate in such a manner that the plurality of radiating sheets is mounted to the insulating bracket. The plurality of second assembling portions and the plurality of first assembling portions fixedly cooperate in such a manner that the insulating bracket in mounted to the feeding network circuit board. The feeding network circuit board is electrically connected to the feeding pin to feed a signal.

As an improvement, the bracket body is a hollow square bracket, the plurality of the mounting portions is evenly distributed along a circumference of the bracket body, the top of the bracket body extends upward to form two pairs of top connecting tabs, the bottom of the bracket body extends downward to form two pairs of bottom connecting tabs, the plurality of second fixing portions includes four bosses, and each of the four bosses is disposed on one corresponding top connecting tab of the two pairs of top connecting tabs. The plurality of first assembling portions includes a first positioning post, a second positioning post, a first fixing snap-joint and a second fixing snap-joint. The first positioning post and the second positioning post are arranged on a group of opposite bottom connecting tabs of the two pairs of bottom connecting tabs, and the first fixing snap joint and the second fixing snap joint are arranged on another group of opposite bottom connecting tabs of the two pairs of bottom connecting tabs.

As an improvement, the plurality of first fixing portions includes four first fixing portions corresponding to the four bosses, each of the four first fixing portions includes a plurality of sawtooth spring corners, and each of the four bosses is inserted to a mounting groove defined by the plurality of the sawtooth spring corners, in such a manner that the plurality of the sawtooth spring corners generates an elastic deformation force to fasten the boss.

As an improvement, the plurality of second assembling portions includes a first positioning hole, a second positioning hole, a first snap groove and a second snap groove that are provided in the feeding network circuit board; in an assembling process, the first positioning post is pre-positioned in the first positioning hole, the second positioning post is pre-positioned in the second positioning hole, and by pressing the insulating bracket, the first fixing snap joint is connected in the first snap groove, and the fixing second snap joint is connected in the second snap groove.

As an improvement, the plurality of feeding sheets includes four feeding sheets, each of the four feeding sheets includes a first feeding body, and a second feeding body and a third feeding body that are each connected to the first feeding body, the feeding pin is provided at bottom of the second feeding body, and the third feeding body is formed by extending downward from one side of the first feeding body. The plurality of mounting portions includes four mounting portions corresponding to the four feeding sheets, each of the four mounting portions includes a receiving sleeve and a positioning snap-joint formed at a top of the receiving sleeve. A plug-slot is provided at a side of the positioning snap-joint, a feeding channel is formed at a middle portion of the receiving sleeve and has a shape same as an outer shape of the second feeding body, the second feeding body passes through the feeding channel, the third feeding body is received in the plug-slot in such a manner that a degree of freedom of the feeding sheet is limited in a first dimension and a second dimension, and the positioning snap joint is configured to tightly press the first feeding body in such a manner that the degree of freedom of the feeding sheet is limited in a third dimension.

As an improvement, four polarization power division lines are provided on the feeding network circuit board and correspond to the four feeding sheets, each of polarization directions of the four polarization power division lines is +45 degrees or −45 degree, and connecting terminals of the four polarization power division lines are respectively connected to the feeding pins of the four feeding sheets in a welding manner.

As an improvement, the radiating sheet is a square or circular metal sheet having a thickness smaller than 0.2 mm, each of the plurality of feeding sheets is a metal sheet made of electroplating of aluminum alloy or made of copper-nickel-zinc alloy, and each of the plurality of sawtooth spring corners is formed by a wire cutting process or a stamping process.

As an improvement, the insulating bracket is integrally formed by a plastic injection molding process.

A second aspect, an embodiment of the present invention provides a lightweight array antenna, including a feeding network circuit board and a plurality of the lightweight antenna units welded on the feeding network circuit board. Each of the plurality of lightweight antenna units includes: a radiating sheet, an elastic first fixing portion being provided on the radiating sheet; an insulating bracket; and a plurality of feeding sheets. The insulating bracket includes a bracket body, and a plurality of mounting portions, a plurality of second fixing portions and a plurality of first assembling portions that are mounted to the bracket body. The plurality of second fixing portions is provided at a top of the bracket body, and the plurality of first assembling portions is provided at a bottom of the bracket body. A plurality of second assembling portions and a feeding network are provided on the feeding network circuit board. Each of the plurality of feeding sheets is received in a corresponding mounting portion of the plurality of mounting portions in such a manner that a feeding pin at bottom of the feeding sheet extends out of the corresponding mounting portion. The plurality of first fixing portions and the plurality of second fixing portions cooperate in such a manner that the plurality of radiating sheets is mounted to the insulating bracket. The plurality of second assembling portions and the plurality of first assembling portions fixedly cooperate in such a manner that the insulating bracket is mounted to the feeding network circuit board. The feeding network circuit board is electrically connected to the plurality of feeding pins of the plurality of feeding sheets to feed signals.

As an improvement, the bracket body is a hollow square bracket, the plurality of the mounting portions is evenly distributed along a circumference of the bracket body, the top of the bracket body extends upward to form two pairs of top connecting tabs, the bottom of the bracket body extends downward to form two pairs of bottom connecting tabs, the plurality of second fixing portions includes four bosses, and each of the four bosses is disposed on one corresponding top connecting tab of the two pairs of top connecting tabs. The plurality of first assembling portions includes a first positioning post, a second positioning post, a first fixing snap-joint and a second fixing snap-joint. The first positioning post and the second positioning post are arranged on a group of opposite bottom connecting tabs of the two pairs of bottom connecting tabs, and the first fixing snap joint and the fixing second snap joint are arranged on another group of opposite bottom connecting tabs of the two pairs of bottom connecting tabs.

As an improvement, the plurality of first fixing portions includes four first fixing portions corresponding to the four bosses, each of the four first fixing portions includes a plurality of sawtooth spring corners, and each of the four bosses is inserted to a mounting groove defined by the plurality of the sawtooth spring corners, in such a manner that the plurality of the sawtooth spring corners generates an elastic deformation force to fasten the boss.

As an improvement, the plurality of second assembling portions includes a first positioning hole, a second positioning hole, a first snap groove and a second snap groove that are provided in the feeding network circuit board; in an assembling process, the first positioning post is pre-positioned in the first positioning hole, the second positioning post is pre-positioned in the second positioning hole, and by pressing the insulating bracket, the first fixing snap joint is connected in the first snap groove, and the second fixing snap joint is connected in the second snap groove.

As an improvement, the plurality of feeding sheets includes four feeding sheets, each of the four feeding sheets includes a first feeding body, and a second feeding body and a third feeding body that are each connected to the first feeding body, the feeding pin is provided at a bottom of the second feeding body, and the third feeding body is formed by extending downward from one side of the first feeding body. The plurality of mounting portions includes four mounting portions corresponding to the four feeding sheets, each of the four mounting portions includes a receiving sleeve and a positioning snap-joint formed at a top of the receiving sleeve. A plug-slot is provided at a side of the positioning snap-joint, a feeding channel is formed at a middle portion of the receiving sleeve and has a shape same as an outer shape of the second feeding body, the second feeding body passes through the feeding channel, the third feeding body is received in the plug-slot in such a manner that a degree of freedom of the feeding sheet is limited in a first dimension and a second dimension, and the positioning snap joint is configured to tightly press the first feeding body in such a manner that the degree of freedom of the feeding sheet is limited in a third dimension.

As an improvement, four polarization power division lines are provided on the feeding network circuit board and correspond to the four feeding sheets, each of polarization directions of the four polarization power division lines is +45 degrees or −45 degree, and connecting terminals of the four polarization power division lines are respectively connected to the feeding pins of the four feeding sheets in a welding manner.

As an improvement, the radiating sheet is a square or circular metal sheet having a thickness smaller than 0.2 mm, each of the plurality of feeding sheets is a metal sheet made of electroplating of aluminum alloy or made of copper-nickel-zinc alloy, and each of the plurality of sawtooth spring corners is formed by a wire cutting process or a stamping process.

As an improvement, the insulating bracket is integrally formed by a plastic injection molding process.

A third aspect, an embodiment of the present invention provides an assembly method of an antenna unit, including:

inserting a plurality of feeding sheets to a plurality of mounting portions of an insulating bracket, respectively, fastening the plurality of feeding sheets to the plurality of mounting portions, and arranging a feeding pin located at a bottom of each of the plurality of feeding sheets in such a manner that the feeding pin extends out of a corresponding one of the plurality of mounting portions;

mounting the insulating bracket equipped with the plurality of feeding sheets to a feeding network circuit board by fixedly cooperating between a first assembling portions of the feeding network circuit board and a second assembling portion located at bottom of the insulating bracket;

welding the plurality of the feeding sheets and a feeding network of the feeding network circuit board by the plurality of feeding pins of the plurality of feeding sheets to feed signals; and

mounting a radiating sheet to the insulating bracket by cooperating between a first fixing portion of the radiating sheet and a second fixing portion arranged at a top of the insulating bracket.

The lightweight antenna unit, the lightweight array antenna, and the assembly method for the antenna unit of the present embodiment adopt a lightweight insulating bracket to assemble the radiating sheet and the feeding sheet to reduce the weight of each of the antenna units. The radiating sheet is mounted to the elastic first fixing portion, for example, a sawtooth spring corner, which can be directly plug-connected with the second fixing portion of the bracket, to improve the assembly efficiency. In the lightweight antenna unit, the array antenna, and the assembly method for the antenna unit of the present embodiment, each feeding sheet is stably supported on the bracket through the corresponding mounting portion and then connected to the feeding network circuit board at one time, such that the subsequent welding operation has a better effect to ensure product stability. The feeding welding points are only configured to connect the feeding sheet, and there are few feeding welding points. In the lightweight antenna unit, the array antenna, and the assembly method for the antenna unit of the present embodiment, the plurality of the mounting portions is evenly distributed along the circumference of the bracket body to obtain better polarization performance. The lightweight antenna unit of the present embodiment can be pre-mounted on the feeding network circuit board stably through the cooperation between the first assembling portions and the second assembling portions, which is suitable for subsequent automated production and processing and leads a high assembly accuracy.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a schematic diagram of a lightweight antenna unit;

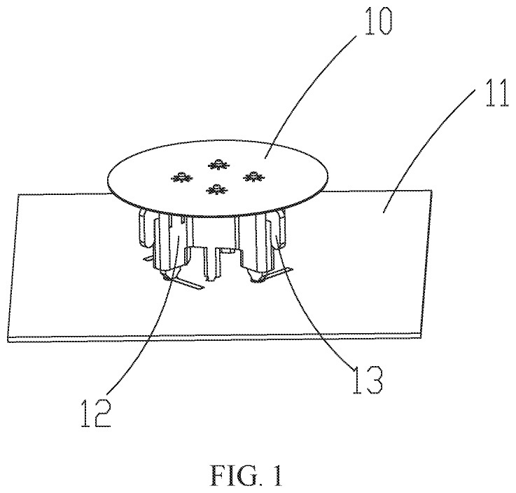

FIG. 2 is a perspective exploded schematic diagram of a lightweight antenna unit;

FIG. 3 is an enlarged schematic diagram of a first fixing portion of a lightweight antenna unit;

FIG. 4 is an enlarged schematic diagram of a feeding sheet of a lightweight antenna unit;

FIG. 5 is a schematic diagram of an insulating bracket of a lightweight antenna unit from a first perspective;

FIG. 6 is a schematic diagram of an insulating bracket of a lightweight antenna unit from a second perspective; and

FIG. 7 is a schematic diagram of a lightweight array antenna; and

FIG. 8 is a flowchart of an assembly method for an antenna unit.

### DESCRIPTION OF EMBODIMENTS

In order to make technical solutions and advantages of the present invention clearer, the present invention will be described in further detail with reference to the accompanying drawings and embodiments. It should be understood that the specific embodiments described herein are only used to explain the present invention and are not used to limit the present invention.

The present invention will be further illustrated with reference to the accompanying drawings and the embodiments.

It should be noted that if there are directional indications (such as up, down, left, right, front, back . . . ) in the embodiments of the present invention, then the directional indications are only used to explain relative positional relationship, movement, etc. of various components under a specific posture (as shown in the drawings), if the specific posture changes, the directional indications also change accordingly.

In addition, if there are descriptions related to “first”, “second”, etc. in the present invention, they are for descriptive purposes only and cannot be understood as indicating or implying their relative importance or implicitly indicating the number of technical features indicated. Thus, features defined as “first” and “second” may include at least one of the features explicitly or implicitly. In addition, the technical solutions between the various embodiments can be combined with each other, but they must be based on the ability of those skilled in the art to realize. When the combination of the technical solutions contradicts or cannot be achieved, it should be considered that the combination of such technical solutions does not exist, nor within the protection scope claimed by the present invention.

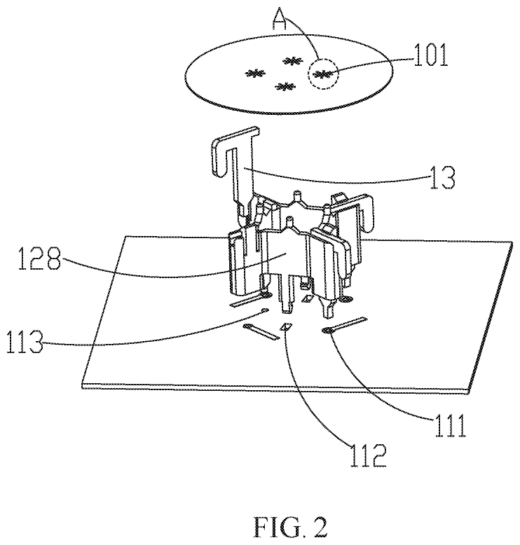

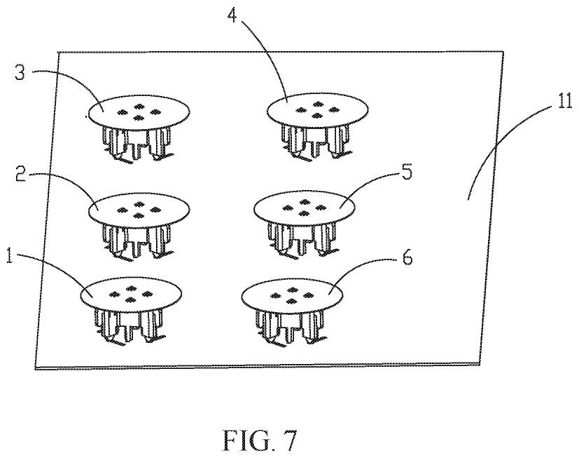

Referring to FIG. 2 and FIG. 7, the present invention relates to a lightweight antenna unit, an array antenna using the antenna unit, and an assembly method for the antenna unit. The array antenna is formed by welding a plurality of antenna units 1-6 to a feeding network circuit board 11, and it is suitable for 5G large-scale array antennas.

Each lightweight antenna unit includes a radiating sheet 10, an insulating bracket 12, and a plurality of feeding sheets. The antenna unit and the array antenna of the present invention use a lightweight insulating bracket to assemble the radiating sheet 10 and the plurality of the feeding sheets. In addition, mounting of the radiating sheet 10 adopts an easy-operation elastic buckling method to be directly and efficiently plug-connected with a second fixing portion of the insulating bracket 12. The feeding sheet is stably supported on the insulating bracket 12 by mounting portions and then welded to the feeding network circuit board 11, and feeding welding points are only used to connect the feeding sheet, so that there are few feeding welding points. The mounting portions are evenly distributed along a circumference of a bracket body 128 to obtain a better antenna polarization performance. The lightweight antenna unit can be quickly and stably pre-mounted through a second assembling portion provided on the feeding network circuit board 11 with cooperation of the first assembling portion, to facilitate subsequent automated production and processing.

The lightweight antenna unit of the array antenna is provided as the insulating bracket 12 integrally formed by plastic injection molding, the radiating sheet 10 is mounted on an upper portion of the bracket, and polarization directions of the four feeding sheets are set to ±45°, thereby ensuring the antenna unit to have characteristic of multi-polarization, multi-band, high power capacity, and strong array anti-interference ability, and high dimensional accuracy.

Referring to FIG. 7, the present embodiment relates to a lightweight array antenna and an antenna unit.

Referring to FIG. 2 in combination, the array antenna includes the feeding network circuit board 11 and the plurality of the antenna units welded on the feeding network circuit board 11, such as an antenna unit 1, an antenna unit 2, an antenna unit 3, an antenna unit 4, an antenna unit 5 and an antenna unit 6 that are shown in FIG. 7.

Referring to FIG. 2 in combination, each antenna unit includes the radiating sheet 10, the insulating bracket 12, and the plurality of the feeding sheets. In an embodiment, there are four feeding sheets, and description below is introduced taking a first feeding sheet 13 as an example, with the other feeding sheets having the same structure as the first feeding sheet 13.

The insulating bracket 12 includes the bracket body 128 and a plurality of mounting portions, and a plurality of second fixing portions, and a plurality of first assembling portions that are provided on the bracket body 128.

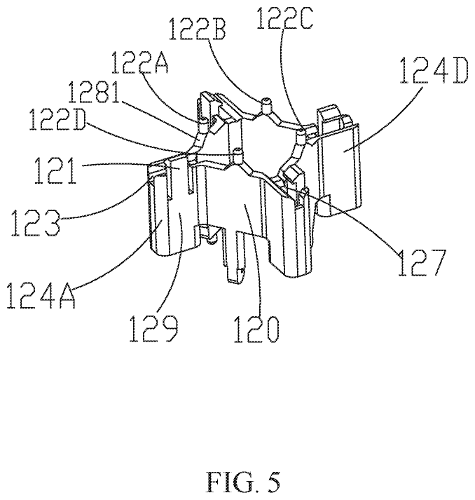

Referring to FIG. 5 in combination, the second fixing portions includes four bosses protruding above the bracket body 128, and the bosses correspond to sawtooth spring corners arranged on the radiating sheet 10. The four bosses includes a first boss 122A, a second boss 122B, a third boss 122C, and a fourth boss 122D.

The bracket body 128 is a hollow square bracket, and the plurality of mounting portions is evenly distributed along the circumference of the bracket body 128. A top of the bracket body 128 extends upward to form two pairs of top connecting tabs, such as top connecting tabs 1281. A bottom of the bracket body 128 extends downward to form two pairs of bottom connecting tabs, such as a bottom connecting tab 1283 and a bottom connecting tab 1284. The plurality of second fixing portions includes four bosses, and each bosses is respectively disposed on the corresponding top connecting tab. For example, the first boss 122A is disposed on the top connecting tab 1281.

The plurality of first assembling portions includes a first positioning post 1251, a second positioning post 1252, a first fixing snap joint 1261, and a second fixing snap joint 1262 that are provided at the bottom of the bracket body 128.

The first positioning post and the second positioning post are arranged on a group of bottom connecting tabs that are opposite to each other. For example, the first positioning post is disposed on the bottom connecting tab 1283. The first fixing snap joint and the second fixing snap joint are arranged on another group of the bottom connecting tabs that are opposite to each other. For example, the first fixing snap joint 1261 is disposed on the bottom connecting tab 1284.

The feeding network circuit board 11 is provided with the second assembling portion cooperating with the first assembling portion of each antenna unit.

On a side of the feeding network circuit board 11 opposite to the antenna unit, four polarization power division lines are provided corresponding to each antenna unit. Connecting terminals of the four polarization power division lines are respectively welded to feeding pins of the corresponding feeding sheets to realize feeding connection, such as a connecting terminal 111 of one of the polarization power division lines. In the present embodiment, polarization directions of the four polarization power division lines are +/−45 degrees.

As shown in FIG. 2, the plurality of second assembling portions includes a first positioning hole 113, a second positioning hole, a first snap groove 112 and a second snap groove that are provided in the feeding network circuit board 11.

During an assembly process of the antenna unit and the feeding network circuit board 11, the first positioning post 1251 is pre-positioned in the first positioning hole 113, the second positioning post 1252 is pre-positioned in the second positioning hole (obscured), and by pressing the insulating bracket 12, the first fixing snap joint 1261 can be tightly clamped in the first snap groove 112, and the second fixing snap joint 1262 can be tightly clamped in the second snap groove.

The structure of the antenna unit will be introduced as follows.

Referring to FIG. 2, the antenna unit includes the radiating sheet 10, the insulating bracket 12, the four feeding sheets, and the feeding network circuit board 11. As shown in FIG. 2, the four feeding sheets are a first feeding sheet 13, a second feeding sheet, a third feeding sheet, and a fourth feeding sheet. The following description is illustrated taking the first feeding sheet 13 as an example, and the other feeding sheets have the same structure as the first feeding sheet 13.

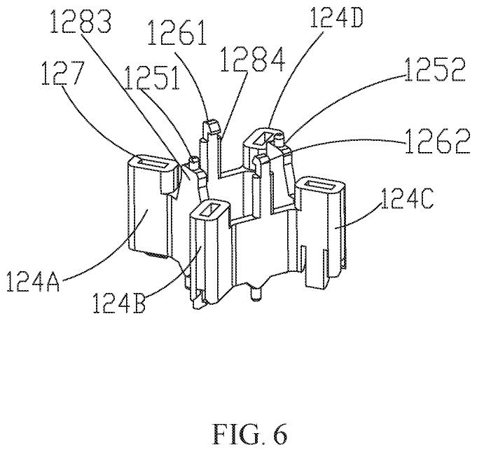

As shown in FIG. 6, the insulating bracket 12 includes a bracket body 128 and a plurality of mounting portions, a plurality of second fixing portions, and a plurality of first assembling portions that are provided on the bracket body 128. The mounting portions are provided corresponding to the feeding sheets, and include a first mounting portion 124A, a second mounting portion 124B, a third mounting portion 124C, and a fourth mounting portion 124D.

In an embodiment, the radiating sheet 10 is a square or circular metal sheet and has a thickness smaller than 0.2 mm. The radiating sheet 10 is provided with elastic first fixing portions. In an embodiment, the first fixing portions include at least two sawtooth spring corners 101, and the sawtooth spring corner 101 is made by a wire cutting process or a stamping process. In an embodiment, the radiating sheet 10 is provided with four sawtooth spring corners.

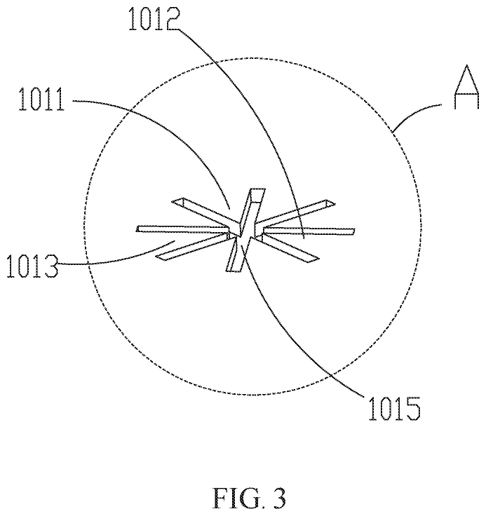

As shown in FIG. 3, each sawtooth spring corner includes a plurality of contact tabs, such as a first contact tab 1011, a second contact tab 1012, and a third contact tab 1013. Plug-connection gaps 1015 are formed between the plurality of the contact tabs and at a center.

When assembling the radiating sheet 10, the four bosses at the top of the insulating bracket 12 are inserted into the four sawtooth spring corners of the radiating sheet 10. A corner edge of each sawtooth spring corners is deformed by an external force, and the corner edge of the sawtooth spring corner 101 reversely buckles the corresponding boss. The mounting and fixation of the radiating sheet 10 are achieved by buckling engagement of the plurality of the sawtooth spring corners of the radiating sheet 10 with the bosses of the insulating bracket 12. A first assembling portion configured to pre-mount the entire antenna unit on the feeding network circuit board 11 is provided at the lower portion of the insulating bracket 12.

The plurality of the mounting portions 124A-124D is evenly distributed along the circumference of the bracket body 128 to obtain better antenna polarization performance.

In an embodiment, the structure is described by taking the first mounting portion 124A and the second mounting portion 124B as examples, and the other mounting portions have same structures. The first mounting portion 124A includes a receiving sleeve 129 and a positioning snap joint 121 formed at top of the receiving sleeve 129, and a plug-slot 123 is provided at a side of the positioning snap-joint 121. A middle portion of the receiving sleeve forms a feeding channel, such as a feeding channel 127 of the second mounting portion 124B, and a shape of the feeding channel is the same as an outer shape of the second feeding body. The second feeding body passes through the corresponding feeding channel, and the third feeding body 131 is received in the plug-slot in such a manner that a degree of freedom of the feeding sheet is limited in a first dimension and a second dimension; and the positioning snap joint tightly presses the corresponding first feeding body in such a manner that the degree of freedom of the corresponding feeding sheet is limited in a third dimension.

Each feeding sheet is a metal sheet, and it is made of aluminum alloy electroplating or made of copper-nickel-zinc alloy.

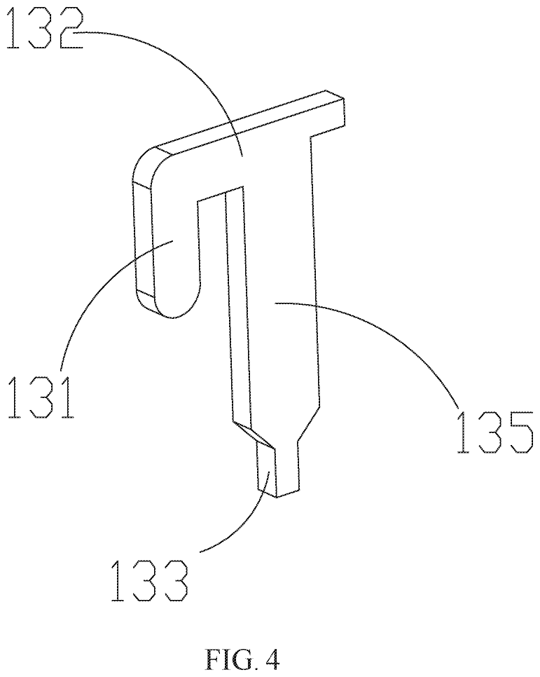

As shown in FIG. 4, the first feeding sheet 13 includes a first feeding body 132, a second feeding body 135 and a third feeding body 131. The feeding pin 133 is disposed at bottom of the second feeding body 135, and the third feeding body 131 is formed by extending downward from one side of the first feeding body 132.

The first feeding sheet 13 is received in the corresponding first mounting portion 124A in such a manner that the feeding pin 133 of the first feeding sheet 13 extends out of the first mounting portion 124A. The first fixing portion and the second fixing portion cooperate to mount the radiating sheet 10 to the insulating bracket 12.

The first assembling portion is configured to cooperate the second assembling portion provided on the feeding network circuit board 11 to pre-fix the antenna unit on the feeding network circuit board 11, and the first assembling portions include a first positioning post 1251, a second positioning post 1252, a first fixing snap-joint 1261 and a second fixing snap-joint 1262 that are provided at the bottom of the bracket body 128.

The four feeding channels formed by the four mounting portions of the insulating bracket 12 are also evenly distributed along the circumference of the bracket body 128, and the positioning snap joint on the upper portion of each feeding channel tightly buckles the first feeding body of the corresponding feeding sheet. When assembling, the feeding sheet is inserted to the corresponding feeding channel, and after the feeding sheet is inserted to the bottom, the positioning snap joint fixes the feeding sheet, and the plug-slot at a side of each feeding channel is provided with an oblique angle to facilitate insertion of the feeding sheet.

During production and assembly, the four feeding sheets are respectively inserted into the plug-slots of plastic bracket to pre-fix, then the plastic bracket is directly inserted to the feeding network circuit board 11, and the first positioning post 1251 and the second positioning post 1252 at the bottom of the plastic bracket respectively cooperate to the first positioning hole and the second positioning hole of the feeding network circuit board 11. The first fixing snap-joint 1261 and the second fixing snap-joint 1262 at the bottom of the insulating bracket 12 are respectively fixed in the first plug-slot and the second plug-slot of the feeding network circuit board 11. After that, the feeding pins of the four feeding sheets are respectively welded to the connecting terminals of the four polarization power division lines having the polarization directions of +/−45 degrees and arranged on the feeding network circuit board 11, to realize the feeding connection. Finally, the radiating sheet 10 is inserted into the four bosses located on the top of the insulating bracket 12, i.e., the first boss, the second boss, the third boss, and the fourth boss, to complete the assembly of one of the antenna units.

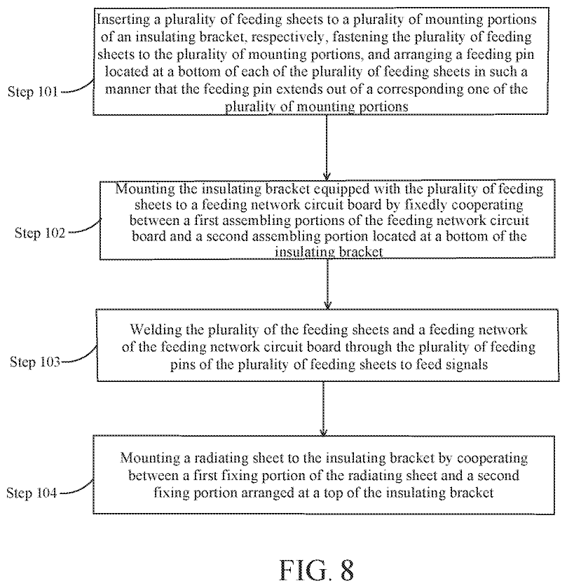

Referring to FIG. 8, an assembly method for the antenna unit of the present embodiment is shown, and it includes following steps.

At step 101, a plurality of feeding sheets are inserted into and are fastened to corresponding mounting portions of the insulation bracket, and a feeding pin at bottom of each feeding sheet are extended out of the corresponding mounting portion.

At step 102, the insulating bracket equipped with the feeding sheets is mounted to the feeding network circuit board by fixedly cooperating between a first assembling portion of the feeding network circuit board and a second assembling portion located at the bottom of the insulating bracket.

At step 103, the plurality of the feeding sheets and a feeding network of the feeding network circuit board are welded through the feeding pins, to feed signals.

At step 104, the radiating sheet is mounted to the insulating bracket by cooperating between a first fixing portion of the radiating sheet and a second fixing portion located at top of the insulating bracket.

The lightweight antenna unit, the lightweight array antenna, and the assembly method for the antenna unit of the present embodiment adopt a lightweight insulating bracket to assemble the radiating sheet 10 and the feeding sheet to reduce the weight of each antenna unit. The mounting of the radiating sheet 10 adopts the elastic first fixing portion, for example, a sawtooth spring corner, which can be directly plug-connected to the second fixing portion of the bracket, to improve the assembly efficiency. In the lightweight antenna unit and the array antenna of the present embodiment, each feeding sheet is stably supported on the bracket through the corresponding mounting portion and then connected to the feeding network circuit board 11, such that the subsequent welding operation has a better effect and product stability is better. The feeding welding points are only configured to connect the feeding sheet, and there are few feeding welding points. In the lightweight antenna unit and the array antenna of the present embodiment, the plurality of the mounting portions is evenly distributed along the circumference of the bracket body 128 to obtain better polarization performance. The lightweight antenna unit of the present embodiment can be pre-mounted on the feeding network circuit board 11 stably through the cooperation between the first assembling portion and the second assembling portion, such that it is suitable for subsequent automated production and processing, the assembly accuracy is high, and the antenna unit is suitable for manufacturing 5G large-scale array antennas.

In the lightweight antenna unit, the lightweight array antenna, and the assembly method for the antenna unit of the present embodiment, the radiating sheet 10 of the antenna unit is made of a stainless-steel sheet, and the insulating bracket 12 is engineering plastic, the feeding sheet is a small-sized metal sheet, so an overall design can reduce the weight of the antenna unit and lower manufacturing cost of the antenna. A plurality of components between the lightweight antenna unit and the feeding network circuit board 11 of the present embodiment are all fixed by buckling at one time, and there are only four necessary feeding welding points, the welding points are few, it is easy for automated production and assembly, an assembly error is small, and the consistency of the antenna performance is good. The entire antenna unit is light in weight, low in cost, and highly automated.

The above is only the embodiments of the present invention and does not limit the patent scope of the present invention. Any equivalent structure or equivalent process transformation made by using the description and the accompany drawings of the present invention, or those directly or indirectly used in other related technical fields, are also included in the scope of protection of the present invention.

What is claimed is:

1. A lightweight antenna unit, comprising:
a radiating sheet provided with a plurality of first fixing portions that is elastic;
an insulating bracket comprising a bracket body, and a plurality of mounting portions, a plurality of second fixing portions and a plurality of first assembling portions that are mounted to the bracket body, wherein the plurality of second fixing portions is provided at a top of the bracket body, and the plurality of first assembling portions is provided at a bottom of the bracket body;
a plurality of feeding sheets, wherein each of the plurality of feeding sheets is received in a corresponding mounting portion of the plurality of mounting portions in such a manner that a feeding pin at a bottom of the feeding sheet extends out of the corresponding mounting portion; and
a feeding network circuit board comprising a plurality of second assembling portions and a feeding network,
wherein the plurality of first fixing portions and the plurality of second fixing portions cooperate in such a manner that the plurality of radiating sheets is mounted to the insulating bracket,
the plurality of second assembling portions and the plurality of first assembling portions fixedly cooperate in such a manner that the insulating bracket is mounted to the feeding network circuit board, and
the feeding network circuit board is electrically connected to the feeding pin to feed a signal.

2. The lightweight antenna unit as described in claim 1, wherein the bracket body is a hollow square bracket, the plurality of mounting portions is evenly distributed along a circumference of the bracket body, the top of the bracket body extends upwards to form two pairs of top connecting tabs, and the bottom of the bracket body extends downwards to form two pairs of bottom connecting tabs;
the plurality of second fixing portions comprises four bosses, and each of the four bosses is disposed on one corresponding top connecting tab of the two pairs of top connecting tabs; and
the plurality of first assembling portions comprises a first positioning post, a second positioning post, a first fixing snap-joint and a second fixing snap-joint, wherein the first positioning post and the second positioning post are arranged on a group of opposite bottom connecting tabs of the two pairs of bottom connecting tabs, and the first fixing snap joint and the second fixing snap joint are arranged on another group of opposite bottom connecting tabs of the two pairs of bottom connecting tabs.

3. The lightweight antenna unit as described in claim 2, wherein the plurality of first fixing portions comprises four first fixing portions corresponding to the four bosses, each of the four first fixing portions comprises a plurality of sawtooth spring corners, and each of the four bosses is inserted to a mounting groove defined by the plurality of the sawtooth spring corners, in such a manner that the plurality of the sawtooth spring corners generates an elastic deformation force to fasten the boss.

4. The lightweight antenna unit as described in claim 2, wherein the plurality of second assembling portions comprises a first positioning hole, a second positioning hole, a first snap groove and a second snap groove that are provided in the feeding network circuit board; in an assembling process, the first positioning post is pre-positioned in the first positioning hole, the second positioning post is pre-positioned in the second positioning hole, and by pressing the insulating bracket, the first fixing snap joint is connected in the first snap groove, and the second fixing snap-joint is connected in the second snap groove.

5. The lightweight antenna unit as described in claim 1, wherein the plurality of feeding sheets comprises four feeding sheets, each of the four feeding sheets comprises a first feeding body, and a second feeding body and a third feeding body that are each connected to the first feeding body, the feeding pin is provided at bottom of the second feeding body, and the third feeding body is formed by extending downward from one side of the first feeding body; and
the plurality of mounting portions comprises four mounting portions corresponding to the four feeding sheets, each of the four mounting portions comprises a receiving sleeve and a positioning snap joint formed at a top of the receiving sleeve, wherein a plug-slot is provided at a side of the positioning snap-joint, a feeding channel is formed at a middle portion of the receiving sleeve and has a shape same as an outer shape of the second feeding body, the second feeding body passes through the feeding channel, the third feeding body is received in the plug-slot in such a manner that a degree of freedom of the feeding sheet is limited in a first dimension and a second dimension, and the positioning snap joint is configured to tightly press the first feeding body in such a manner that the degree of freedom of the feeding sheet is limited in a third dimension.

6. The lightweight antenna unit as described in claim 5, wherein four polarization power division lines are provided on the feeding network circuit board and correspond to the four feeding sheets, each of polarization directions of the four polarization power division lines is +45 degrees or −45 degree, and connecting terminals of the four polarization power division lines are respectively connected to the feeding pins of the four feeding sheets in a welding manner.

7. The lightweight antenna unit as described in claim 3, wherein the radiating sheet is a square or circular metal sheet having a thickness smaller than 0.2 mm, each of the plurality of feeding sheets is a metal sheet made of electroplating of aluminum alloy or made of copper-nickel-zinc alloy, and each of the plurality of sawtooth spring corners is formed by a wire cutting process or a stamping process.

8. The lightweight antenna unit as described in claim 1, wherein the insulating bracket is integrally formed by a plastic injection molding process.

9. A lightweight array antenna, comprising:
a feeding network circuit board; and
a plurality of lightweight antenna units welded on the feeding network circuit board,
wherein each of the plurality of lightweight antenna units comprises:
a radiating sheet provided with a plurality of first fixing portions that is elastic;
an insulating bracket comprising a bracket body, and a plurality of mounting portions, a plurality of second fixing portions and a plurality of first assembling portions that are mounted to the bracket body, wherein the plurality of second fixing portions is provided at a top of the bracket body, and the plurality of first assembling portions is provided at a bottom of the bracket body; and
a plurality of feeding sheets, wherein each of the plurality of feeding sheets is received in a corresponding mounting portion of the plurality of mounting portions in such a manner that a feeding pin at a bottom of the feeding sheet extends out of the corresponding mounting portion;
wherein a plurality of second assembling portions and a feeding network are provided on the feeding network circuit board,
the plurality of first fixing portions and the plurality of second fixing portions cooperate in such a manner that the plurality of radiating sheets is mounted to the insulating bracket,
the plurality of second assembling portions and the plurality of first assembling portions fixedly cooperate in such a manner that the insulating bracket is mounted to the feeding network circuit board, and
the feeding network circuit board is electrically connected to the plurality of feeding pins of the plurality of feeding sheets to feed signals.

10. The lightweight array antenna as described in claim 9, wherein the bracket body is a hollow square bracket, the plurality of mounting portions is evenly distributed along a circumference of the bracket body, the top of the bracket body extends upward to form two pairs of top connecting tabs, and the bottom of the bracket body extends downward to form two pairs of bottom connecting tabs;
the plurality of second fixing portions comprises four bosses, and each of the four bosses is disposed on one corresponding top connecting tab of the two pairs of top connecting tabs; and
the plurality of first assembling portions comprises a first positioning post, a second positioning post, a first fixing snap-joint and a second fixing snap-joint, wherein the first positioning post and the second positioning post are arranged on a group of opposite bottom connecting tabs of the two pairs of bottom connecting tabs, and the first fixing snap joint and the second fixing snap joint are arranged on another group of opposite bottom connecting tabs of the two pairs of bottom connecting tabs.

11. The lightweight array antenna as described in claim 10, wherein the plurality of first fixing portions comprises four first fixing portions corresponding to the four bosses, each of the four first fixing portions comprises a plurality of sawtooth spring corners, and each of the four bosses is inserted to a mounting groove defined by the plurality of the sawtooth spring corners, in such a manner that the plurality of the sawtooth spring corners generates an elastic deformation force to fasten the boss.

12. The lightweight array antenna as described in claim 10, wherein the plurality of second assembling portions comprises a first positioning hole, a second positioning hole, a first snap groove and a second snap groove that are provided in the feeding network circuit board; in an assembling process, the first positioning post is pre-positioned in the first positioning hole, the second positioning post is pre-positioned in the second positioning hole, and by pressing the insulating bracket, the first fixing snap joint is connected in the first snap groove, and the second fixing snap-joint is connected in the second snap groove.

13. The lightweight array antenna as described in claim 9, wherein the plurality of feeding sheets comprises four feeding sheets, each of the four feeding sheets comprises a first feeding body, and a second feeding body and a third feeding body that are each connected to the first feeding body, the feeding pin is provided at bottom of the second feeding body, and the third feeding body is formed by extending downward from one side of the first feeding body; and
the plurality of mounting portions comprises four mounting portions corresponding to the four feeding sheets, each of the four mounting portions comprises a receiving sleeve and a positioning snap-joint formed at a top of the receiving sleeve, wherein a plug-slot is provided at a side of the positioning snap-joint, a feeding channel is formed at a middle portion of the receiving sleeve and has a shape same as an outer shape of the second feeding body, the second feeding body passes through the feeding channel, the third feeding body is received in the plug-slot in such a manner that a degree of freedom of the feeding sheet is limited in a first dimension and a second dimension, and the positioning snap joint is configured to tightly press the first feeding body in such a manner that the degree of freedom of the feeding sheet is limited in a third dimension.

14. The lightweight antenna unit as described in claim 13, wherein four polarization power division lines are provided on the feeding network circuit board and correspond to the four feeding sheets, each of polarization directions of the four polarization power division lines is +45 degrees or −45 degree, and connecting terminals of the four polarization power division lines are respectively connected to the feeding pins of the four feeding sheets in a welding manner.

15. The lightweight antenna unit as described in claim 11, wherein the radiating sheet is a square or circular metal sheet having a thickness smaller than 0.2 mm, each of the plurality of feeding sheets is a metal sheet made of electroplating of aluminum alloy or made of copper-nickel-zinc alloy, and each of the plurality of sawtooth spring corners is formed by a wire cutting process or a stamping process.

16. The lightweight antenna unit as described in claim 9, wherein the insulating bracket is integrally formed by a plastic injection molding process.

17. An assembly method for an antenna unit, comprising:
inserting a plurality of feeding sheets to a plurality of mounting portions of an insulating bracket, respectively, fastening the plurality of feeding sheets to the plurality of mounting portions, and arranging a feeding pin located at a bottom of each of the plurality of feeding sheets in such a manner that the feeding pin extends out of a corresponding one of the plurality of mounting portions;
mounting the insulating bracket equipped with the plurality of feeding sheets to a feeding network circuit board by fixedly cooperating between a first assembling portions of the feeding network circuit board and a second assembling portion located at a bottom of the insulating bracket;
welding the plurality of the feeding sheets and a feeding network of the feeding network circuit board through the plurality of feeding pins of the plurality of feeding sheets to feed signals; and
mounting a radiating sheet to the insulating bracket by cooperating between a first fixing portion of the radiating sheet and a second fixing portion arranged at a top of the insulating bracket.
